(19) United States
(12) Patent Application Publication
(10) Pub. No.: US 2011/0084954 A1
(43) Pub. Date: Apr. 14, 2011

(54) ORGANIC LIGHT EMITTING DISPLAY DEVICE AND DRIVING METHOD FOR THE SAME

(75) Inventors: Wook LEE, Yongin-city (KR); Sung-Cheon PARK, Yongin-city (KR); Sung-Un PARK, Yongin-city (KR)

(73) Assignee: SAMSUNG MOBILE DISPLAY CO., LTD., Yongin-city (KR)

(21) Appl. No.: 12/796,726

(22) Filed: Jun. 9, 2010

(30) Foreign Application Priority Data
Oct. 12, 2009 (KR) 10-2009-0096758

(51) Int. Cl. G09G 5/00

(52) U.S. Cl. 345/212

(57) ABSTRACT

An organic light emitting display device that includes: a pixel unit that displays an image by receiving a data signal, a scan signal, a first pixel power, and a second pixel power; a regulator that receives first input voltage from the outside and boosts the received first input voltage to generate the first pixel power and inverts the received first input voltage to generate second pixel power; a driver driving unit that includes a power generator and a signal generator generating the data signal and the scan signal. Further, a switching unit that selectively connects the pixel unit with the regulator or the pixel unit with the driver driving unit; and a control unit that transmits the first pixel power and the second pixel power generated by the regulator or the driver driving unit to the pixel unit.

### CLAIMS OF PRIORITY

This application makes reference to, incorporates into this specification the entire contents of, and claims all benefits accruing under 35 U.S.C. §119 from an application earlier filed in the Korean Intellectual Property Office filed on Oct. 12, 2009 and there duly assigned Serial No. 10-2009-0096758.

### BACKGROUND OF THE INVENTION

1. Field of the Invention

The embodiment relates to an organic light emitting display (OLED) device and a driving method for the same.

2. Discussion of Related Art

Recently, various flat panel display devices having smaller weight and volume than a cathode ray tube have been developed and in the flat display device, a pixel unit is formed by disposing a plurality of pixels on a substrate in a matrix form and pixels are displayed on the pixel unit by connecting a scan line and a data line to each pixel and selectively applying a data signal to the pixel.

The flat panel display device is classified into a passive matrix-type display device and an active matrix-type display device in accordance with a driving scheme of the pixels and the active matrix-type that selectively lights unit pixels in terms of resolution, contrast, and operation speed is primarily used.

The flat display device is used as a display device such as a personal computer, a mobile phone, a PDA, or the like or monitors of various information equipments. An LCD using a liquid crystal panel, an organic light emitting display device using an organic light emitting device, a PDP using a plasma panel, etc. are used as the flat display device. In particular, an organic light emitting display (OLED) device that is excellent in emission efficiency, luminance, and a viewing angle and fast in response speed attract public attention.

The above information disclosed in this Related Art section is only for enhancement of understanding of the background of the invention and therefore it may contain information that does not form the prior art that is already known to a person of ordinary skill in the art.

### SUMMARY OF THE INVENTION

Exemplary embodiments are disclosed for an organic light emitting display (OLED) device capable of reducing power consumption while partial driving or in a standby mode and a driving method for the same.

According to an aspect of the present invention, an organic light emitting display device includes: a pixel unit that displays an image by receiving a data signal, a scan signal, a first pixel power, and a second pixel power; a regulator that receives first input voltage from the outside and boosts the received first input voltage to generate the first pixel power and inverts the received first input voltage to generate second pixel power; a driver driving unit that includes a power generator receiving second input voltage from the outside to generate the first pixel power and the second pixel power and first driving power and second driving power and gray scale voltage and a signal generator generating the data signal and the scan signal; a switching unit that selectively connects the pixel unit with the regulator or the pixel unit with the driver driving unit; and a control unit that transmits the first pixel power and the second pixel power generated by the regulator or the driver driving unit to the pixel unit and controls the number of a plurality of voltages generated by the gray scale voltage generator to be less than the number of plural gray scale voltages generated by the regulator when the first pixel power and the second pixel power are generated by the driver driving unit.

According to another aspect, a driving method for the same includes: displaying an image by generating the first pixel power and the second pixel power in a regulator in a normal mode; and displaying the image by generating the first pixel power and the second pixel power in a driver driving unit generating the data signal and the scan signal in a partial driving mode or a standby mode, wherein driving of some amplifiers of a plurality of amplifiers generating gray scale voltage generating the data signal in the partial driving mode or the standby mode stops.

By the organic light emitting display device and a driving method for the same, the organic light emitting display device can reduce power consumption in a partial driving mode or a standby mode.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a conceptual diagram showing the structure of an organic light emitting display device according to an embodiment of the present invention.

FIG. 2 is a circuit diagram showing a switch unit adopted in the organic light emitting display device shown in FIG. 1.

FIG. 3 is a circuit diagram showing an embodiment of a pixel adopted in the organic light emitting display device shown in FIG. 2.

FIG. 4 is a structural diagram showing the structure of a power generator adopted in an organic light emitting display device according to an embodiment of the present invention.

### DETAILED DESCRIPTION OF THE INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. Alternatively, when an element is referred to as being “directly on” another element, there are no intervening elements present.

In order to clarify the present invention, elements extrinsic to the description are omitted from the details of this description, and like reference numerals refer to like elements throughout the specification.

In several exemplary embodiments, constituent elements having the same configuration are representatively described in a first exemplary embodiment by using the same reference numeral and only constituent elements other than the constituent elements described in the first exemplary embodiment will be described in other embodiments.

In a conventional organic light emitting display (OLED) device, in case of partial driving, that is, a case in which an image is displayed only in a partial region and the rest region is displayed as a block color and in a standby mode, that is, in a case where the image is not used, the image is displayed in the block color or low luminance, the organic light emitting display device has comparatively larger power consumption than an LCD. The reason for this is that the partial driving can be displayed by turning off some of backlight units and the standby mode can be displayed by turning on all backlight units so as to reduce power consumption consumed in the backlight units in case of the LCD, but in the organic light emitting display device, each pixel displays an image to correspond to the data signal and a first power supply and a second power supply. Displaying a gray scale corresponds to the data signal at the first power supply. Therefore, even when black is displayed in the pixel, a data signal representing black and the first power supply should be received.

At this time, the organic light emitting display generates the first power supply and the second power supply by using a switching regulator. The switching regulator has low efficiency due its characteristic and the organic light emitting display device needs to consume dozens of mWs in order to actuate the switching regulator, the organic light emitting display device has power consumption comparatively larger than the LCD.

As a result, when the organic light emitting display device is used for a portable terminal such as a mobile phone, etc., the organic light emitting display device has very large power consumption, such that the organic light emitting display device cannot be used for a long time.

Hereinafter, embodiments of the present invention will be described with reference to the accompanying drawings.

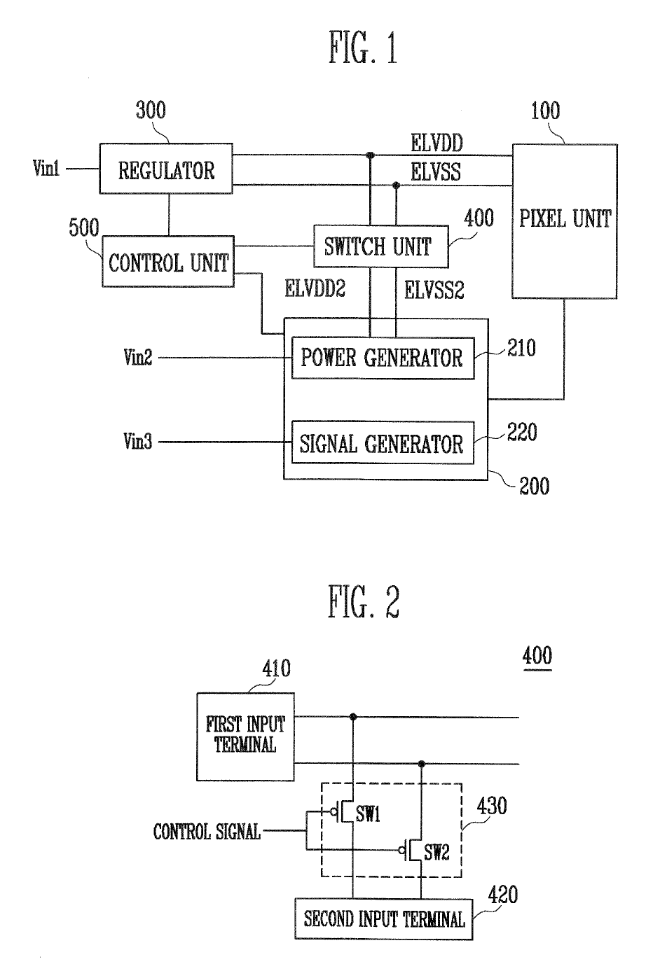

FIG. 1 is a conceptual diagram showing the structure of an organic light emitting display device according to an embodiment of the present invention. Referring to FIG. 1, the organic light emitting display device includes a pixel unit 100, a driver driving unit 200, a regulator 300, a switch unit 400, and a control unit 500.

The pixel unit 100 includes a plurality of pixels, a plurality of data lines that transmit data signals to the pixels, a plurality of scan lines that transmit a plurality of scan signals to the pixels, and a first pixel power lines and a second pixel power lines that transmit first pixel power and second pixel power for driving the pixels. Herein, the second pixel power line is generally constituted by one layer covering the entirety of the pixel unit 100.

Further, the pixel unit 100 is driven by being divided into a normal driving mode in which an image is displayed in the entire region of the pixel unit 100, a partial driving mode in which the image is displayed in a predetermined region of the pixel unit 100, and a standby mode in which the luminance of the pixel unit 100 is set to a low value when a user does not use the pixel unit 100.

In the normal mode, all pixels receive the data signals to display the image. In addition, in the partial driving mode, a data signal displaying a black color is transmitted to a part except for the predetermined region where the image is displayed and a normal data signal is transmitted to the region where the image is displayed. At this time, in the partial driving mode, simple information including time, date, etc, is displayed in the region where the image is displayed. Further, in the standby mode, while all the pixels receive the data signals, it is possible to reduce power consumption by reducing the luminance to a predetermined value or less.

At this time, in the partial driving mode or the standby mode, since only a part of the pixel unit 100 is driven or the luminance is low, the load of the pixel unit 100 is set to a very small value. Therefore, in comparison with the normal mode, the first pixel power and the second pixel power do not need to have large power consumption.

The driver driving unit 200 includes a power generator 210 and a signal generator 220. In addition, the power generator 210 generates the first pixel power and the second pixel power which are the driving power of the pixel and the first driving power and the second driving power which are the driving power for driving the signal generator 220 by using second input voltage Vin2. The signal generator 220 includes a data driving unit and a scan driving unit. In addition, the driver driving unit 200 is driven by third input voltage Vin3.

The regulator 300 receives power from the outside and generates and transmits first pixel power ELVDD and second pixel power ELVSS to the pixel unit 100. The first power and the second power that are generated in the regulator 300 are transmitted to the pixel unit 100 in the normal mode.

The switch unit 400 enables the first pixel power ELVDD and the second pixel power ELVSS generated in the regulator 300 to be transmitted to the pixel unit 100 and disables the first pixel power EVLDD and the second pixel power ELVSS generated in the power generator 210 to be transmitted to the pixel unit 100. In addition, in the partial driving mode or the standby mode, the first pixel power ELVDD and the second pixel power ELVSS that are generated in the regulator 300 are intercepted and the first pixel power ELVDD and the second pixel power ELVSS that are generated in the power generator 210 are transmitted to the pixel unit 100.

The control unit 500 controls operations of the driver driving unit 200, the regulator 300, and the switch unit 400. In the normal mode, the control unit 500 enables the regulator 300 to be driven and the switch unit 400 enables the pixel unit 100 and the regulator 300 to be connected to each other. Therefore, the first pixel power ELVDD and the second pixel power ELVSS that are generated in the regulator 300 are transmitted to the pixel unit 100. In addition, in the partial driving mode or the standby mode, the control unit 500 stops the operation of the regulator 300 and the pixel unit 100 and the driver driving unit 200 are connected to each other by the switch unit 400. Therefore, the first pixel power ELVDD and the second pixel power ELVSS that are generated in the regulator 200 are transmitted to the pixel unit 100.

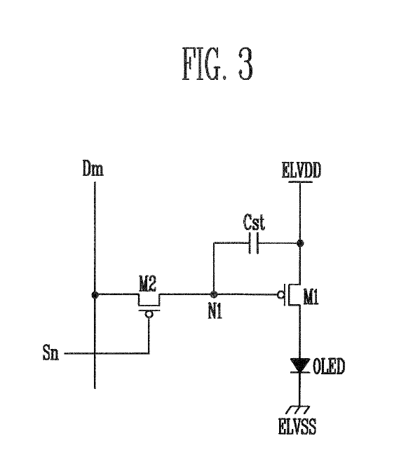

FIG. 2 is a circuit diagram showing a switch unit adopted in the organic light emitting display device shown in FIG. 1. Referring to FIG. 2, the switch unit 400 includes a first input terminal 410 that receives the first pixel power and the second pixel power from the regulator, a second input terminal 420 that receives the first pixel power and the second pixel power from the driver driving unit, and first and second switches SW1 and SW2 that switch the first pixel power EVLDD and the second pixel power ELVSS inputted at the second input terminal 420 into each other.

A first terminal of the first input terminal 410 is connected to an output terminal of the regulator and a second terminal of the first input terminal 410 is connected to the first pixel power line and the second pixel power line that transmit the first pixel power and the second pixel power of the pixel unit. The second terminal receives the first pixel power and the second pixel power from the regulator and transmits them to the pixel unit.

A first input terminal of the second input terminal 420 is connected to the power generator and a second terminal of the second input terminal 420 is connected to the first pixel power line and the second pixel power line that transmit the first pixel power and the second pixel power of the pixel unit through the first switch SW1 and the second switch SW2 to receive the first pixel power and the second pixel power from the power generator and transmit them to the pixel unit.

The first and second switches SW1 and SW2 perform a switching operation by receiving a control signal from the control unit and are connected between the second input terminal and the first pixel power line and the second pixel power line. In addition, when driving the regulator stops, the first and second switches SW1 and SW2 are turned on to enable third power ELVDD2 and fourth power ELVSS2 generated in the driver driving unit to be transmitted to the first pixel power line and the second pixel power line through the second input terminal 420.

FIG. 3 is a circuit diagram showing an embodiment of a pixel adopted in the organic light emitting display device shown in FIG. 2. Referring to FIG. 3, the pixel of the organic light emitting display device is connected to a data line Dm, a scan line Sn, and the first pixel power ELVDD and the second pixel power ELVSS and includes an organic light emitting diode OLED, a first transistor ME a second transistor M2, and a capacitor Cst.

The organic light emitting diode OLED includes an anode electrode, a light emitting layer, and a cathode electrode. The light emitting layer is constituted by a plurality of organic layers between the anode electrode and the cathode electrode. In addition, when first pixel power ELVDD having high voltage is connected to the anode electrode and second pixel power ELVSS having lower voltage than the first pixel power ELVDD is connected to the cathode electrode, current flows from the anode electrode to the cathode electrode and the light emitting layer emit light to correspond to the flow of the current.

A source of the first transistor M1 is connected to the first pixel power ELVDD, a drain is connected between the organic light emitting diodes OLED, and a gate is connected to a first node N1 to adjust the amount of the current that flows from the anode to the cathode of the organic light emitting diode OLED in accordance with the voltage of the gate. That is, a light emission amount of the organic light emitting diode OLED is controlled depending on the voltage of the gate of the first transistor M1.

A source of a second transistor M2 is connected to the data line Dm, a drain is connected to the first node N1, and a gate is connected to the scan line Sn to transmit the data signal transmitted through the data line Dm to the first node N1 to correspond to the scan line Sn.

The capacitor Cst is connected between the first node N1 and the first pixel power ELVDD to maintain the voltage of the first node N1 for one frame time.

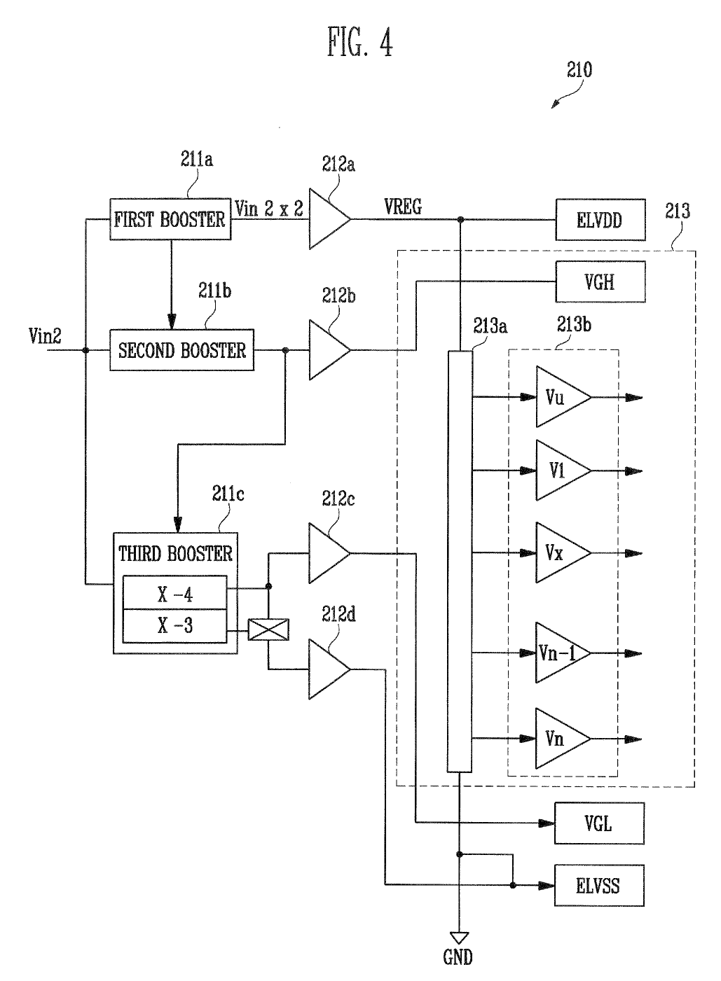

FIG. 4 is a structural diagram showing the structure of a power generator adopted in an organic light emitting display device according to an embodiment of the present invention. The power generator 210 includes a first booster 211a, a second booster 211b, a third booster 211c, and a gray scale voltage generator 213.

The first booster 210 boosts up second input voltage VCI double and thereafter, outputs the first pixel power ELVDD through a buffer 212a. The second booster 211b receives second input voltage Vin2 and output voltage of the first booster 211a and boosts up them to voltage three times larger than the second input voltage Vin2 and thereafter, outputs first driving power VGH through the buffer 212b. When the second booster 211b receives only the second input voltage Vin2, the second input voltage Vin2 needs to be amplified three times in order to generate the first driving voltage VGH, but when the second booster 211b receives the output voltage of the first booster 211a, since the output voltage of the first booster 211a which is boosted up from the second input voltage Vin2 twice is boosted up, it is more efficient. After the third booster 211c receives the output voltage of the second booster 211b and the second input voltage Vin2 and boosts up and inverts them, the third booster 211c outputs second driving power VGL and the second pixel power ELVSS through the buffer 212c and the buffer 212d. The second driving power VGL has voltage −3 times smaller than the second input voltage Vin2 and the second pixel power ELVSS has voltage −4 times of the second input voltage Vin2.

The gray scale voltage generator 213 operates by receiving the first driving power VGH and the second riving power VGL or ground power GND. The gray scale voltage generator 213 includes a resistor array 213a formed between the first driving power VGH and the second driving power VGL or the ground power GND and a buffer unit 213b that amplifies and outputs voltage distributed by the resistor array 213a as gray scale voltage.

At this time, in the normal mode, the gray scale voltage generator 213 distributes the first pixel power EVLDD and the second pixel power ELVSS received from the regulator to generate the gray scale voltage and outputs all gray scale voltage by driving all buffers of the buffer unit 213b. However, in the partial driving mode or the standby mode, the image does not need to display all gray scales. Therefore, even though the gray scale voltage generator generates only a part of the gray scale voltage, the image can display the partial driving mode or the standby mode.

As a result, since the gray scale voltage generator 213 displays the image by using all the gray scales in the normal mode, the first pixel power EVLDD and the second pixel power ELVSS of the resistor array 213a received from the regulator are transmitted to both ends of the resistor array 211a and all the buffers of the buffer unit 213b that output the voltage distributed in the resistor array 211a are driven.

On the contrary, in the partial driving mode or the standby mode, since the image does not use all the gray scales, the first pixel power ELVDD received from the booster 211a and the second pixel power ELVSS of the resistor array 213a received from the third booster 211c are transmitted to both ends of the resistor array 211a and only some of the buffers of the buffer unit 213b that output the voltage distributed in the resistor array 211a are driven to output only a part of the gray scale voltage. Accordingly, the number of driven buffers is decreased to reduce the power consumption. Further, when the ground power GND is used instead of the second pixel power ELVSS, the driving of the buffer 212d that outputs the second pixel power ELVSS can stop in the third booster 211c generating the second pixel power ELVSS, thereby reducing the power consumption.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and-equivalents thereof.

What is claimed is:

1. An organic light emitting display device, comprising:
a pixel unit that displays an image by receiving a data signal, a scan signal, a first pixel power, and a second pixel power;
a regulator that receives first input voltage from the outside and boosts the received first input voltage to generate the first pixel power and inverts the received first input voltage to generate second pixel power;
a driver driving unit that includes a power generator receiving second input voltage from the outside to generate the first pixel power and the second pixel power and first driving power and second driving power and gray scale voltage and a signal generator generating the data signal and the scan signal;
a switching unit that selectively connects the pixel unit with the regulator or the pixel unit with the driver driving unit; and
a control unit that transmits the first pixel power and the second pixel power generated by the regulator or the driver driving unit to the pixel unit and controls a number of a plurality of voltages generated by the gray scale voltage generator to be less than the number of plural gray scale voltages generated by the regulator when the first pixel power and the second pixel power are generated by the driver driving unit.

2. The organic light emitting display device of claim 1, wherein the power generator includes:
a first booster that generates the first pixel power;
a second booster that generates the first driving power;
a third booster that generates the second pixel power and the second driving power; and
a gray scale voltage generator that generates gray scale voltage by voltage-dividing the first pixel power and the second pixel power.

3. The organic light emitting display device of claim 2, wherein the gray scale voltage generator voltage-divides the first pixel power and the second pixel power and outputs the divided voltages through a buffer unit including a plurality of buffers and drives only some buffers of the buffer unit when the first pixel power and the second pixel power are inputted at the first and third boosters.

4. The organic light emitting display device of claim 1, wherein the power generator includes:
a first booster that generates the first pixel power;
a second booster that generates the first driving power;
a third booster that generates the second pixel power and the second driving power; and
a gray scale voltage generator that generates gray scale voltage by voltage-dividing the first pixel power and ground power.

5. The organic light emitting display device of claim 4, wherein the power generator includes a gray scale voltage generator that stops driving of a buffer amplifying the second pixel power.

6. The organic light emitting display device of claim 1, wherein in a normal mode, the first pixel power and the second pixel power are transmitted to the pixel unit through the regulator and in a partial driving mode or a standby mode, the first pixel power and the second pixel power are transmitted to the pixel unit through the driver driving unit.

7. The organic light emitting display device of claim 1, wherein the switching unit includes:
a first switch that performs a switching operation by a control signal; and
a second switch that performs the switching operation by the control signal,
wherein the first switch and the second switch are connected between the power generator and a pixel power line and third power and fourth power generated by the power generator by the control signal are selectively transmitted to the pixel power line.

8. A driving method for an organic light emitting display device that displays an image by a data signal, a scan signal, first pixel power, and second pixel power, comprising:
displaying an image by generating the first pixel power and the second pixel power in a regulator in a normal mode; and
displaying the image by generating the first pixel power and the second pixel power in a driver driving unit generating the data signal and the scan signal in a partial driving mode or a standby mode,
wherein driving of some amplifiers of a plurality of amplifiers generating gray scale voltage generating the data signal in the partial driving mode or the standby mode.

9. The driving method for an organic light emitting display device of claim 8, wherein the second pixel power is not outputted in the partial driving mode or the standby mode.

10. The driving method of an organic light emitting display device of claim 8, wherein the gray scale voltage divides voltages of the first pixel power and the second pixel power by using a resistor array in the normal mode and outputs the divided voltages through the plurality of amplifiers, and
the gray scale voltage divides voltages of the first pixel power and the ground power by using the resistor array and outputs the divided voltages through some of the plurality of amplifiers in the partial driving mode or the standby mode.
